(19) United States
(12) Patent Application Publication
(10) Pub. No.: US 2009/0254393 A1
(43) Pub. Date: Oct. 8, 2009

(54) BILLING, DOCKETING AND DOCUMENT MANAGEMENT

(75) Inventor: Evelyne Lollichon, Chantilly, VA (US)

Correspondence Address: GREENBLUM & BERNSTEIN, P.L.C., 1950 ROLAND CLARKE PLACE, RESTON, VA, 20191, US

(73) Assignee: GREENBLUM & BERNSTEIN, P.L.C., Reston, VA (US)

(21) Appl. No.: 12/417,298

(22) Filed: Apr. 2, 2009

Related U.S. Application Data
(60) Provisional application No. 61/042,396, filed on Apr. 4, 2008.
(60) Provisional application No. 61/103,123, filed on Oct. 6, 2008.

(51) Int. Cl. G06Q 10/00

(52) U.S. Cl. 705/7

(57) ABSTRACT

A server and distributed client docketing management system includes a first client computer module on a first client computer that collects administrative information to collect a docketing template for a specified activity. A second client computer module on a second client computer applies the docketing template to a specified file upon determination of occurrence of the specified activity. A third client computer module on a third client computer presents docket entries of the docketing template on a docket for a day on which the docket entries require answers. A fourth client computer module on a fourth client computer presents proposed answers to the docket entries of the docketing template on the docket for the day on which the docket entries require answers.

This application claims priority to Provisional U.S. Patent Application No. 61/042,396, filed on Apr. 4, 2008, and to Provisional U.S. Patent Application No. 61/103,123, filed on Oct. 6, 2008, the disclosures of which are expressly incorporated by reference herein in their entireties.

### BACKGROUND OF THE INVENTION

1. Field of the Invention

The present invention relates to billing, docketing and document management. More particularly, the present invention relates to managing bills, dockets and documents using specific parameters relating to, for example, activity, client and file, and to integrating management of bills, dockets and documents using specific parameters to generate and present bills, dockets and documents and/or templates for bills, dockets and documents.

2. Background Information

Businesses such as law firms expend significant resources to generate bills and documents for different activities, clients and files. Such businesses also expend significant resources to generate and complete dockets which are used to monitor completion of tasks for different activities, clients and files.

For example, a business may dedicate employee resources to drafting bills and documents and generating and monitoring dockets. Bills, dockets and documents vary for different activities, clients and files, and businesses may require that employees draft and complete bills, dockets and documents in accordance with instructions and guidelines that vary for the different activities, clients and files.

Instructions and guidelines for different activities, clients and files may be set in paper files or electronic files stored on an individual computer or a computer network. Billing and document templates for different activities, clients and files may also be set in paper files or electronic files stored on a computer or computer network, so that employees can find and use the templates to begin drafting bills and documents.

Docketing programs have also been developed that allow an employee to generate sets of docketing entries in a docket for different activities, clients and files. A set of docketing entries may be added to a master docket used to provide reminders and to monitor completion of tasks for the business's activities, clients and files. A set of docketing entries may include docketing entries for activities such as obtaining required information, providing completion deadline reminders, forwarding documents to clients for review, forwarding final versions of bills to clients, and filing documents. The set of docketing entries may vary in accordance with the date the docketing entries are added to the master docket, an underlying date used to determine one or more (extendible and/or inextendible) compliance due date for complying with client instructions and guidelines or governmental regulations, or even at the whim of an employee requesting addition of the set of docketing entries. A set of docketing entries may be assigned to a particular employee for completion, and all docket entries may be assigned a priority for completion. The master docket may be based on a spreadsheet format, sortable by priority, file number, client or due date. Typically, docket entries are removed from the master docket upon verification by an employee and/or supervisor that the underlying activity has been completed or is unnecessary.

Some part of the resources devoted to managing bills, dockets and documents may be expended finding and reviewing instructions and guidelines that vary for the different activities, clients and files. Additionally, a master docket may be answered only on each due date by having assigned employees or supervisors review and complete answers to their assigned entries on the master docket, and the answers are then entered by an employee dedicated to maintaining the master docket. Such labor intensive management of bills, dockets and documents presents risks that bills, dockets and documents will not be completed in accordance with the correct instructions and guidelines. The labor intensive management of bills, dockets and documents also presents risks when late information is received that could affect management of the bills, dockets and documents but which is not provided to the proper employee in a timely manner. The labor intensive management of bills, dockets and documents also requires that docket answers be provided on each due date, though the answers may have been known much earlier than the due date.

Efficiencies could be realized with a customizable system for billing, docketing and document management that allows an administrator to customize bill, docket and document templates in accordance with different client, file and/or activity instructions and guidelines. Such bill, docket and document templates could be generated for bills, docket entries and documents in accordance with appropriate billing arrangements and client policies and requirements, and thereby avoid significant manual labor currently required to draft and complete different bills, dockets and documents.

### BRIEF DESCRIPTION OF THE DRAWINGS

The present invention is further described in the detailed description that follows, by reference to the noted drawings by way of non-limiting examples of embodiments of the present invention, in which like reference numerals represent similar parts throughout several views of the drawing, and in which:

FIG. 1 shows an exemplary communications network architecture for billing, docketing and document management, according to an aspect of the present disclosure;

FIG. 2 shows an exemplary method of creating and managing docketing entries for billing, docketing and document management, according to an aspect of the present disclosure;

FIG. 3 is an exemplary computer architecture for a computer used to implement billing, docketing and document management, according to an aspect of the present disclosure;

FIG. 4 is an exemplary configuration of a screen used to implement billing, docketing and document management, according to an aspect of the present disclosure;

FIG. 5 is an exemplary configuration of another screen used to implement billing, docketing and document management, according to an aspect of the present disclosure;

FIG. 6 is an exemplary method of applying a docket template for previously specified activity to a file to create new docket entries for billing, docketing and document management, according to an aspect of the present disclosure;

FIG. 7 is an exemplary method of answering docket entries in a master docket for billing, docketing and document management, according to an aspect of the present disclosure;

FIGS. 8A-8C are exemplary screenshots showing new file management information in a docketing program for billing, docketing and document management, according to an aspect of the present disclosure;

FIGS. 9A-9C are exemplary screenshots showing client management information in a docketing program for billing, docketing and document management, according to an aspect of the present disclosure;

FIGS. 10A-10B are exemplary screenshots showing user management information in a docketing program for billing, docketing and document management, according to an aspect of the present disclosure;

FIGS. 11A-11B are exemplary screenshots showing unique system identifiers called mail codes which are associated in the system specified activities, and a docket template triggered by specified activity information in a docketing program for billing, docketing and document management, according to an aspect of the present disclosure;

FIG. 12 is an exemplary screenshot showing docketing information available by linking to a docketing entry in a daily docket or master docket;

FIG. 13 is an exemplary screenshot showing a pop-up query window used to return docket entries in accordance with data specified by a user;

FIG. 14 is an exemplary screenshot showing a pop-up query window for a user to retrieve documents using a document management system;

FIG. 15 is an exemplary screenshot showing a window for entering professional service information into a bill using a billing management system; and

FIG. 16 is an exemplary screenshot showing a window for entering global billing rules for preparing and presenting bills to clients.

### DETAILED DESCRIPTION OF THE INVENTION

In view of the foregoing, the present invention, through one or more of its various aspects, embodiments and/or specific features or sub-components, is thus intended to bring out one or more of the advantages as specifically noted below.

A docket is a list of reminders and deadlines for completing specified actions. An individual docket entry is an individual reminder or deadline for completing specified actions. A deadline may be a firm deadline, such as a deadline imposed by law, after which rights may be lost or penalties may be imposed. Alternatively, a deadline may be a discretionary deadline, such as a self-imposed deadline set to please a client or a contractual deadline set by contract.

Docket entries are added to a docket based on either previously specified activity or previously unspecified activity. For example, in the context of an intellectual property law firm, docket entries may be added based on activities such as the following:
Receiving communications from a client or sending communications to a client (RFM)
Receiving communications from the U.S. Patent and Trademark Office (RFPTO)
Filing documents with the U.S. Patent and Trademark Office (FPTO)
A Notice of Allowance issued by the U.S. Patent and Trademark Office (NOA)
Any official communication issued by the U.S. Patent and Trademark Office (AD)
A priority patent application being filed (PRD)
Filing a patent application (FD)
A patent application being published by the U.S. Patent and Trademark Office (PD)
An anniversary (PDD)
A patent issued by the U.S. Patent and Trademark Office (ID)

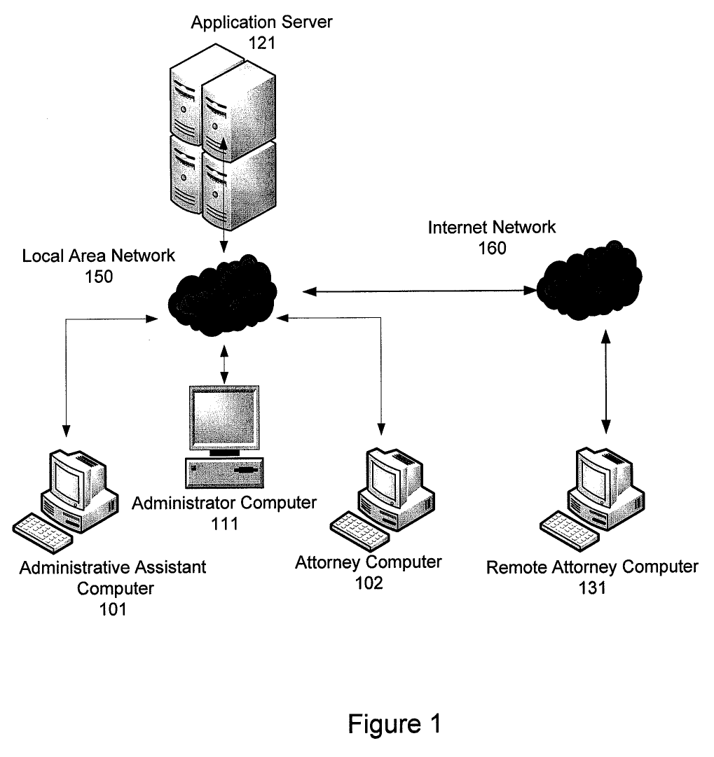

FIG. 1 shows a communications network architecture for billing, docketing and document management. The communications system shown in FIG. 1 includes an administrator computer 111 by which an administrator can enter, delete, revise and access docketing information for billing, docketing and document management.

When activity for a file is recognized which requires application of docket entries, an administrator using the administrator computer 111 in FIG. 1 can open a docketing program, or a docketing component of, e.g., an integrated billing, docketing and document management program, and input data to apply new docket entries to the file. In the herein-contained disclosure, a docketing program integrated with a separate billing program and a separate document management program is considered equivalent to a docketing component of a single, integrated, billing, docketing and document management program. Similarly, a billing program integrated with a separate docketing program and a separate document management program is considered equivalent to a billing component of a single, integrated, billing, docketing and document management program. Moreover, a document management program integrated with a separate docketing program and a billing program is considered equivalent to a document management component of a single, integrated, billing, docketing and document management program. Therefore, in the following description, reference is made to a billing, docketing and document management program, though such a program may be a single, integrated program, or multiple different programs.

The billing, docketing and document management program may be configured as a distributed and shared application, or may be configured as a client/server application. In an embodiment for an intellectual property law firm, the billing, docketing and document management program may also allow multiple levels of access roles, including roles for an administrative assistant, an attorney, a billing assistant, a case management user, a docketing clerk, a docketing manager, an executive manager, a filing manager, a paralegal, an authorized signer for docket entries that require only a single signature for answer, a superuser, a timekeeper, and a timeslip editor. The different roles assigned to users correspond to different levels of authorization to perform specified activities using the billing, docketing and document management program, including viewing docket entries, creating and applying docketing entries, deleting docket entries, preparing answers for docket entries, signing answers for docket entries, approving signed answers for docket entries, creating docket templates for specified activities. The different roles assigned to users also correspond to different levels of authorization to perform specified activities using the billing, docketing and document management program, including viewing documents and document templates, creating document templates and documents, or deleting or editing documents and document templates. The different roles assigned to users also correspond to different levels of authorization to perform specified activities using the billing, docketing and document management program including viewing billing templates, creating billing templates and bills, or deleting or editing billing templates or bills. Administrators may also be provided with functionality for reviewing aggregated or specified statistical information, such as the number of bills in-process, either for an entire organization or a subset of the organization, or the number of unanswered docket entries for a given day for the entire organization or a subset of the organization.

A docketing manager is authorized to create and apply new docketing entries for files. An administrative assistant is authorized to prepare answers for specified docket entries. A paralegal is also authorized to prepare answers for specified docket entries. Both administrative assistants and paralegals are authorized to sign answers for specified docket entries that do not require approval and signature of an attorney. Personnel may be given roles for billing and document management similar to the roles given to personnel for docketing entries.

An attorney is authorized to approve and sign the answers for specified docket entries that require approval and signature of an attorney. A docketing clerk is authorized to approve signed answers for specified docket entries signed by multiple attorneys. A filing manager is authorized to approve signed answers for specified docket entries when the specified docket entries are to be answered by filing documents in the U.S. Patent and Trademark Office. An authorized signer for docket entries that require only a single signature for answer is authorized to sign docket entries that require only a single signature for answer.

A timekeeper is a user for whom timeslips are entered in the billing, docketing and document management program. A billing assistant is authorized to enter timeslips in the billing, docketing and document management program on behalf of timekeepers. A timeslip editor is authorized to edit timeslips in the billing, docketing and document management program on behalf of timekeepers.

Bills may include charges for time spent by specific timekeepers working on a client matter. Bills may also include flat charges agreed upon with a client for performing specified tasks. Bills may also include administrative charges, such as per-page charges for copies and facsimiles, per-minute charges for telephone calls, transactional taxes for underlying charges, or governmental fees such as those incurred for filing documents or for extending due dates for filing documents.

A case management user is authorized to view information in the billing, docketing and document management program. A superuser is authorized to add, delete or revise any data in the billing, docketing and document management program.

The billing, docketing and document management program described herein will apply specific data to templates for bills, dockets and documents in order to create specified bills, dockets and documents. Thus, information specific to clients (e.g., contact person, address) and information specific to files (e.g., title, inventors, filing date, reference numbers) may be obtained and applied to a billing template or document template to create a first draft bill or document. Similarly, templates may themselves vary for different clients, such that a client's preferences may be reflected in templates to which information for specific files is applied.

The administrator computer 111 shown in FIG. 1 is used by a docketing manager or a docketing clerk to create new docket entries for the master docket, or to approve answers for docket entries on the master docket. Based upon receipt of new information for a file, a docketing manager or docketing clerk inputs descriptive information to determine and obtain an appropriate docketing template, and then applies information to the appropriate docketing template to create one or more docketing entries for the file. As an example, receipt of a Notice of Allowance may result in applying the date of the Notice of Allowance to a “Notice of Allowance Docketing Template”. The docketing template for receipt of this new information may vary by client. In the example above, a document template for client “A” may include an entry requiring that the Notice of Allowance be forwarded to client “A” within 1 day of receipt, whereas a document template for client “B” may include an entry requiring that the Notice of Allowance be forwarded to client “B” within 3 days of the Notice of Allowance being issued by the government. Therefore, different docketing templates can be created for different clients, and the docketing manager or docketing clerk can retrieve the appropriate docketing template and apply the appropriate docketing template to a file to create new docket entries upon receipt of new information for a file.

Different computers may be provided for each type of user described above, and functional modules of the billing, docketing and document management program may be partitioned between an application server 121 and these computers. In the embodiment of FIG. 1, administrative assistant computer 101 is used by an administrative assistant to review and prepare an answer to docket entries. Attorney computer 102 is used by attorneys to review, approve and sign answers to docket entries.

The administrative assistant computer 101, the attorney computer 102, and the administrator computer 111 in FIG. 1 communicate with the application server 121 over a local area network 150. In the embodiment of FIG. 1, functional modules of the billing, docketing and document management program are partitioned between the various administrative assistant computer 101, the attorney computer 102, the administrator computer 111, and the application server 121. However, information is shared between the administrative assistant computer 101, the attorney computer 102 and the administrator computer 111. For example, a master docket program may be updated periodically for each of the administrative assistant computer 101, the attorney computer 102 and the administrator computer 111.

Accordingly, if an administrative assistant prepares an answer to a docket entry on the administrative assistant computer 101, the master docket will be updated and the answer to the docket entry will be shown on the master docket as viewed on the attorney computer 102 and the administrator computer 111. When the attorney approves and signs the answer to the docket entry on the attorney computer 102, the master docket will be updated and the signature for the answer to the docket entry will be shown on the master docket as viewed on the administrative assistant computer 101 and the administrator computer 111.

For a large organization responsible for many tasks, a master docket may include thousands of docket entries, responsibility for which is distributed among tens or even hundreds of employees. Thus, docket access, both for viewing and modifying, may vary for different employees based upon their role and specific responsibilities. When a particular employee/user logs on to a docketing component of the billing, docketing and document management program, the portion of the master docket presented to them will be set by default. This information presented by default may be those docket entries for which the employee is responsible, either personally or as a manager. The employee may also be given access to other portions of the master docket, though such access may be limited by access control set by administrators. The employee may select different parts of the master docket for presentation, and/or filter among the selected parts of the master docket by, for example, client, responsible employee, date, priority, answer or status of answer, description of entry, or any other field or portion of field used in the master docket.

Thus, the billing, docketing and document management program described herein allows employees and managers to access all or part of the docket entries of a master docket for the entire organization, and then select and filter docket entries for which access is authorized by administrators. That is, the ability to enter, change, apply, retrieve, view, delete or otherwise work with data of the billing, docketing and document management program may vary for different employees/users, both by access authority provided by administrators and by selection and filtering of data by the employees/users themselves.

Each change entered on any of the administrative assistant computer 101, the attorney computer 102 and the administrator computer 111 will first be registered at the application server 121. That is, the administrative assistant computer 101, the attorney computer 102 and the administrator computer 111 are clients of the application server 121, and the application server 121 coordinates the sharing of information between different clients. Thus, as an employee/user makes any change to a docket entry on the master docket, the change will be reflected in the master docket as shown to other employees/users when the master docket (or portion of the master docket shown to the other employees/users) updates. The various computers in the system of FIG. 1 may be updated automatically for each change, or periodically in the event that docket entries are changed often.

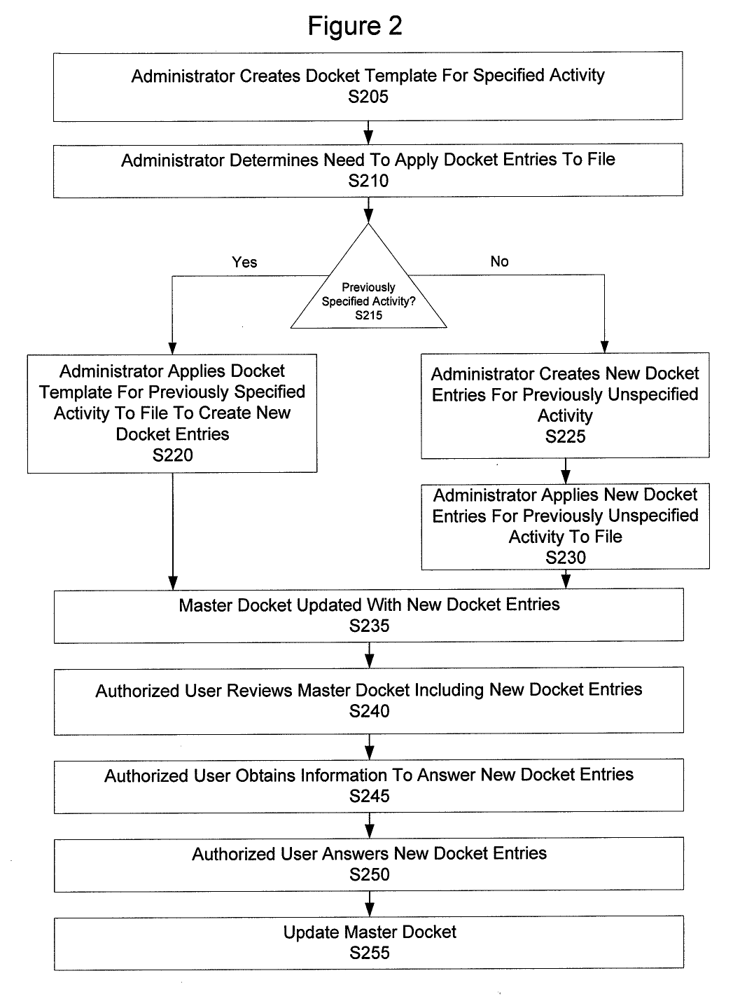

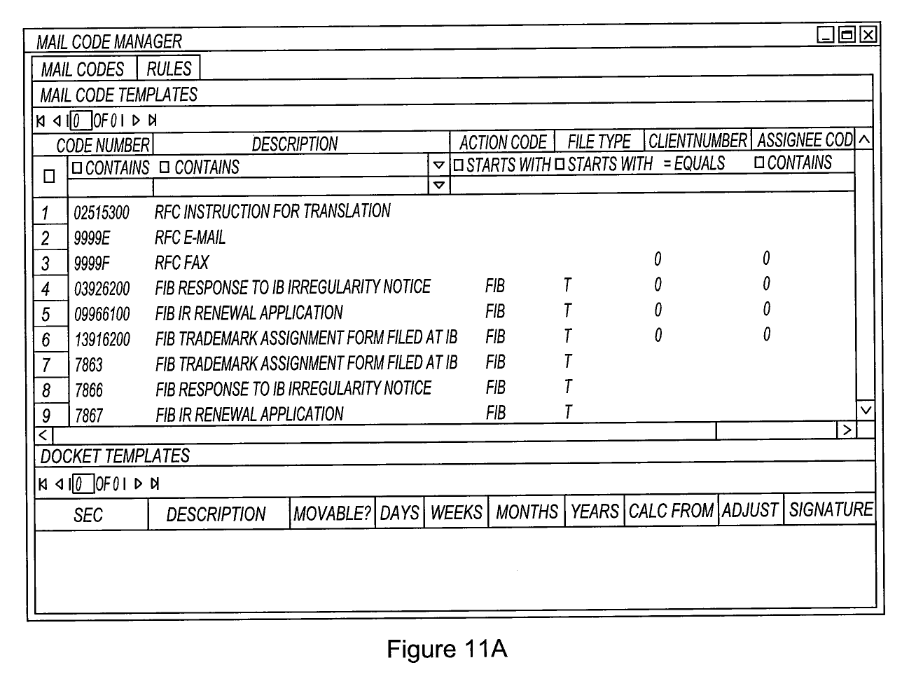

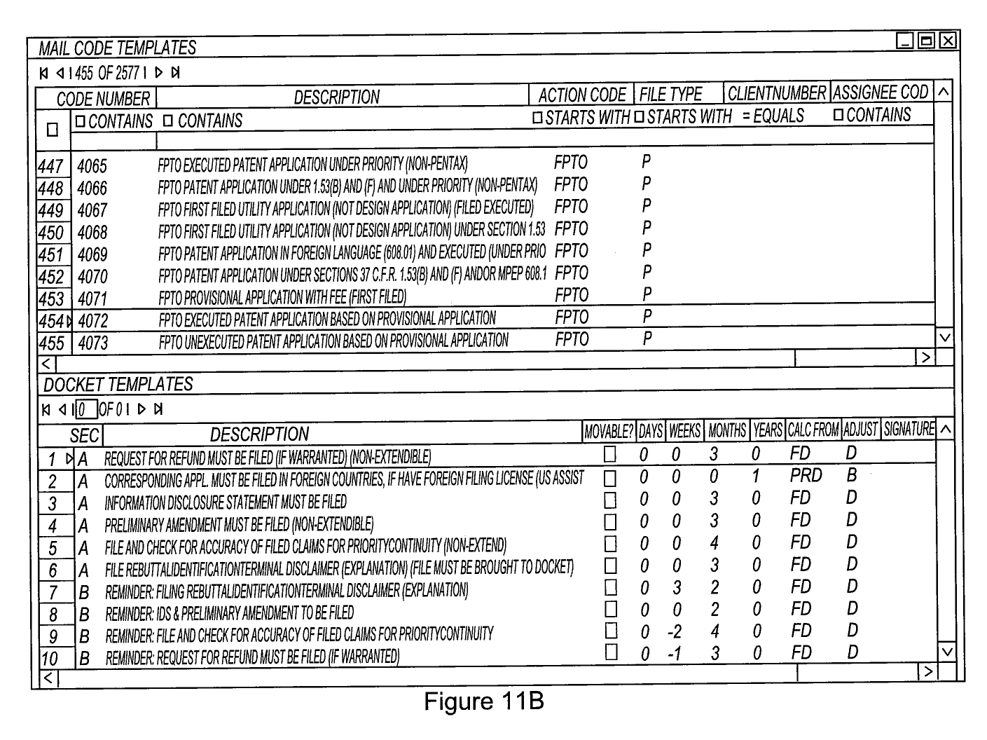

FIG. 2 shows an exemplary method of creating and managing docketing entries for billing, docketing and document management. The method shown in FIG. 2 is an overview of the lifecycle of a docket entry, and includes activities taken by users in a variety of roles as described above. As shown, at step 205 an administrator creates a docket template for a specified activity. The exemplary screenshot in FIG. 11A shows mail codes used to associate specified activities with unique system identifiers. The exemplary screenshot in FIG. 11B shows a docket template triggered by the specified activity of filing an executed patent application based on a provisional patent application in the U.S. Patent and Trademark Office.

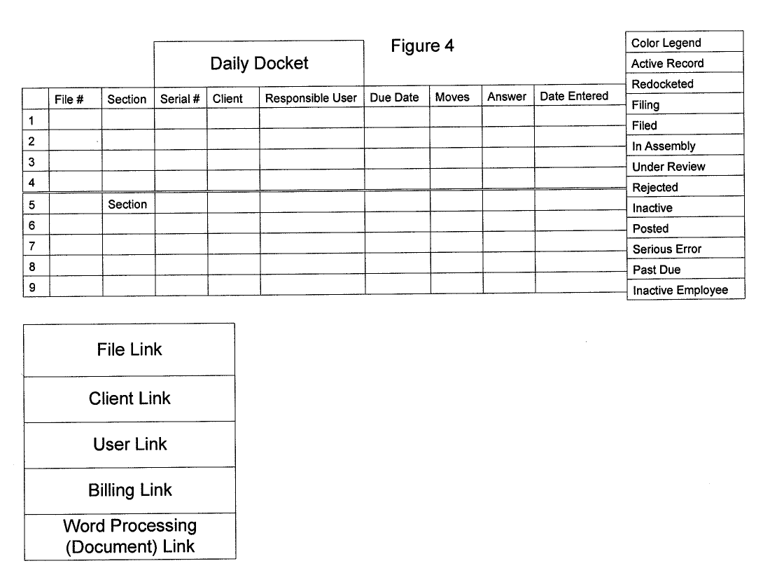

As shown in FIG. 11B, the docket template for filing an executed patent application based on a provisional patent application in the U.S. Patent and Trademark Office includes numerous entries such as, but not limited to:
Request for refund must be filed, if warranted
Corresponding application must be filed in foreign countries, if have foreign filing license
Information Disclosure Statement must be filed
Preliminary Amendment must be filed
File and check for accuracy of filed claims for priority/continuity The docket template shown in FIG. 11B also includes numerous entries for reminding of upcoming due dates such as, but not limited to:
Reminder: IDS and Preliminary Amendment to be filed
Reminder: File and check for accuracy of filed claims for priority/continuity As shown in FIG. 11B, each docket entry is associated with an alphabetic code known as a “section”. Each “section” is a part of the master docket, and is used to group docket entries by relative importance. Deadlines to comply with legal requirements, client requirements or important internal requirements are in an “A” section in the embodiment of FIG. 1IB. Reminders for “A” section docketing entries are in a “B” section. Although not shown in FIG. 11B, additional sections (such as, for example, a “C” section and a “D” section) in the master docket may be provided for completing routine administrative matters, completing billing matters, and for checking status information for files. FIG. 4, which shows the configuration of a “daily docket” screen shows a field section listed next to the file number for each entry.

At step S210, an administrator determines a need to apply docket entries to a file. For instance, a need to apply docket entries to a file may be determined when the administrator receives a request from an attorney, or when the administrator receives an incoming communication from the U.S. Patent and Trademark Office for which a responsive action is required within a fixed statutory deadline. Alternatively, a need to apply docket entries to a file may be determined when the intellectual property law firm files a paper in the U.S. Patent and Trademark Office, such as filing an executed patent application based on a provisional patent application, as in the example shown in FIG. 11B.

At S215, a determination is made as to whether the activity based upon which docketing entries must be generated is an activity previously specified. If the activity has been previously specified (S215=Yes) in the billing, docketing and document system, a docketing template will have previously been created for the activity. However, if the activity has not been previously specified (S215=No) in the billing, docketing and document system, a docketing template will not have been previously created for the activity. If the activity has been previously specified (S215=Yes) in the billing, docketing and document system, the administrator applies the previously created docketing template for the activity to create new docket entries at step S220. If the activity has not been previously specified (S215=No) in the billing, docketing and document system, the administrator creates the new docket entries for the previously unspecified activity at step S225 and applies the newly created docket entries for the previously unspecified activity to the file at step S230. After either step S220 or step S230, the master docket is updated with the newly created docket entries at step S235.

On or before a date on which a docketing entry requires review (e.g., of a reminder in the “B” section) or an answer (e.g., confirmation that a required action has been performed or is not needed or can be delayed), an authorized user such as an administrative assistant reviews the master docket including the new docket entries at step S240. At step S245, the authorized user obtains information sufficient to prepare an answer to the docketing entry. For example, the authorized user may physically obtain the file, or review a networked database of documents and filing or confirmation receipts, and determine an appropriate answer to the docketing entry based on review of the physical file or the documents or receipts in the networked database.

At step S250, the authorized user prepares the answer to the docketing entry requiring answer. For example, the administrative assistant may enter an answer in a designated field of the docketing entry, and save the prepared answer.

At step S255, the master docket is updated. The master docket may be updated only upon an attorney approving and electronically signing the prepared answer for the docketing entry as saved by the administrative assistant. For low priority docket entries, such as docketing entries in the “C” section of the master docket, the administrative assistant may be authorized to approve the prepared answer and electronically sign the docket entry.

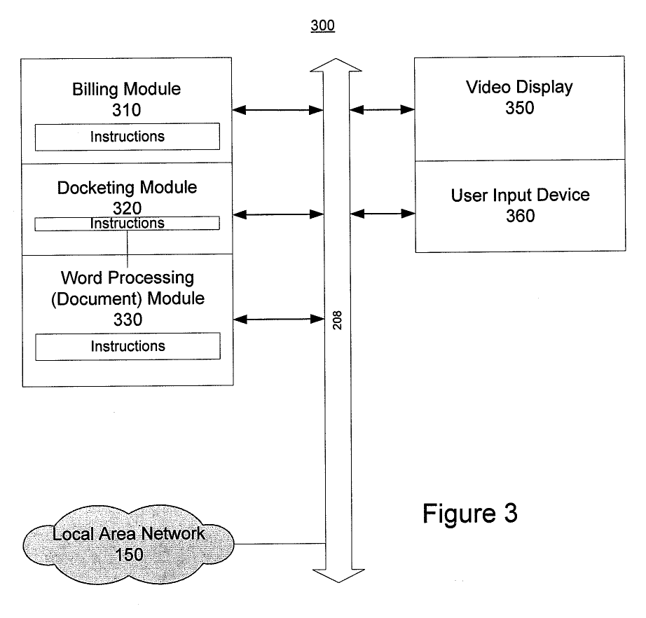

FIG. 3 shows an exemplary computer architecture for a computer used to implement the billing, docketing and document management disclosed herein. As shown, a computer 300 supports a billing module 310, a docketing module 320 and a word processing (document) module 330. Each of the modules 310, 320 and 330 include software instructions for implementing respective aspects of the billing, docketing and document management program. The modules 310, 320 and 330 are partitioned between the application server 121 and computers 101, 102, 111 and 131. As an example, a presentation layer (not shown) is provided on the computers 101, 102, 111 and 131, whereas back end coordination for the billing, docketing and document management program is provided on the application server 121. Therefore, the architecture shown in FIG. 3 is merely representative of billing, docketing and document management functionality being present on any of the application server 121 and computers 101, 102, 111 and 131, even though the computers may not necessarily provide the same access depending on the configuration of the computer as a client or server and depending on the access authorized for a user of the computers 101, 102, 111 and 131. The billing module 310, docketing module 320, work processing (document) module 330, video display 350 and user input device 360 communication via a bus 208 as shown in FIG. 3.

Each computer 300 also includes a user input device 360, which may be one or more peripherals such as a keyboard or mouse. The user of each computer 300 may input data and instructions to the billing, docketing and document management program via the user input device, to access, add or delete information. Each computer 300 also includes a video display 350 by which a user can view display information of the billing, docketing and document management program in a graphical user interface.

FIG. 4 is an exemplary configuration of a screen used to implement billing, docketing and document management. The configuration of the screen shown in FIG. 4 is a display of daily docket information. Daily docket information is a subset of the master docket, and is particular to docket entries which must be reviewed and/or answered on a particular day. As shown, the daily docket information includes, but is not limited to, for example, data in a table display, with a row of data for each entry. The daily docket information shown in FIG. 4 includes an organization's internal file reference number, section (priority), patent serial number, internal client reference identifier, responsible user to whom the file is assigned, due date (the date of the daily docket in this embodiment), the number of times the docket entry has been moved (not finally answered), the answer to the docket entry (including a “move” to another date), and the date the docket entry was added to the master docket. A side bar shows color coding for the various answers to the docket entry, to facilitate review of answers (e.g., “redocketed”, “filing”, “filed”, “in assembly”, “under review”, “posted”, “rejected” or “serious error”) or status for unanswered docket entries such (e.g., “active record” or “past due”, “inactive”). Links are also provided on the screen to:
access information of a specific file for which the docket entry was added to the master docket
access information of a specific client for the file for which the docket entry was added to the master docket
access information of a user of the billing, docketing and document management program
access the billing module of the billing, docketing and document management program
access the word processing (document) module of the billing, docketing and document management program.

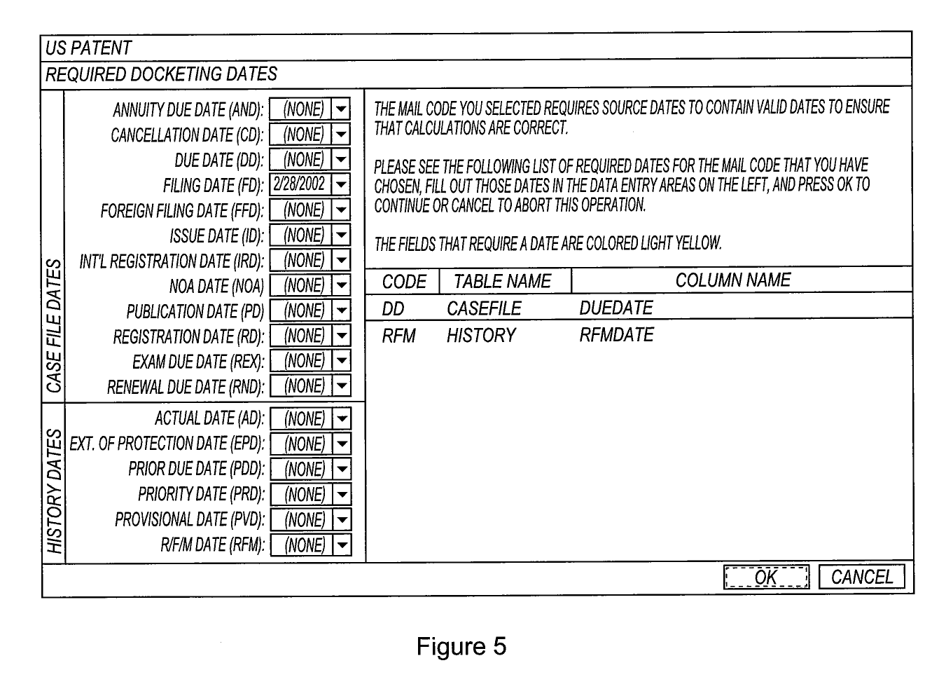

FIG. 5 is an exemplary configuration of another screen used to implement billing, docketing and document management. The screen shown in FIG. 5 is a screen used by a docketing administrator to input date information used to determine docketing due dates. The screen shown in FIG. 5 is a “pop up” screen that appears when a docketing administrator selects the previously specified activity for which a docketing template is used to apply a set of docketing entries to a file. Docketing due dates (including reminder dates) in the template may vary depending on the specific information of underlying activity dates. As an example, if a non-final Office Action is issued by the U.S. Patent and Trademark Office on Mar. 10, 2008, an initial but extendable due date for a Response is three months later on Jun. 10, 2008, or the first business day after Jun. 10, 2008 if Jun. 10, 2008 falls on a weekend or holiday. The due date can be extended by payment of progressive extension of time fees for one month, two months or three months. Although the intellectual property law firm used as the example in this disclosure may receive the Office Action on Mar. 13, 2008, the docketing administrator must determine the actual issue date of the Office Action as being on Mar. 10, 2008 in order for the billing, docketing and document program to calculate the correct initial and extended due dates. Logical calendaring functionality of the billing, docketing and document program can automatically determine the proper due dates based on the issue date of the Office Action, by referencing calendar information of weekends and holidays.

In the screen shot shown in FIG. 5, the set “due date” and a “received/filed/mailed” date are required in order to generate proper docketing due dates for the selected previously specified activity. Other underlying activity dates that may be required to generate docketing due dates for other previously specified activity may include annuity due date, cancellation date, filing date, foreign filing date, issue date, international registration date, notice of allowance date, publication date, registration date, examination due date, renewal due date, actual date, extension of protection date, prior due date, priority date, or provisional date, any or all of which are dates which could be used to determine due dates for a template of docket entries in the example of the intellectual property law firm.

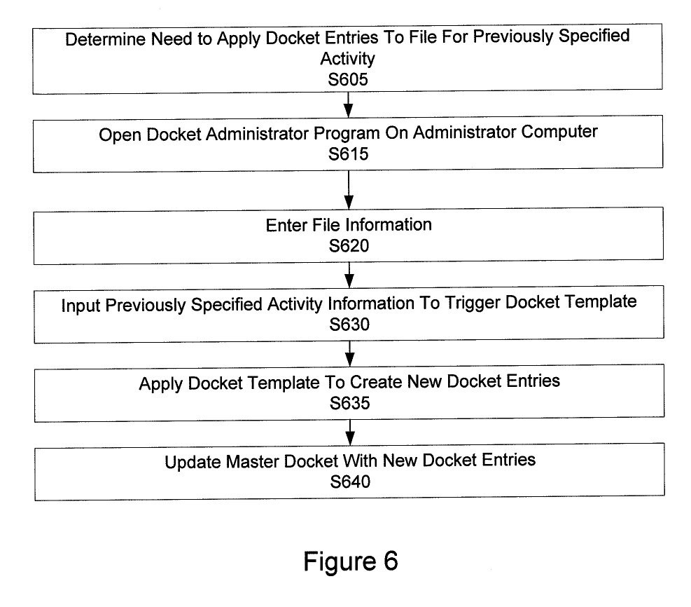

FIG. 6 is an exemplary method of applying a docket template for previously specified activity to a file to create new docket entries for billing, docketing and document management. The method shown in FIG. 6 is an overall series of steps by which the process of applying a template of docket entries to a file results in new docketing entries being added to a master docket. At step S605, a docketing administrator determines a need to apply docket entries to a file for previously specified activity. At step S610, the docket administrator opens the billing, docketing and document program on the docket administrator's computer. At step S620, the docket administrator inputs the file number and the previously specified activity to a docket-entry creation window. At step S630, the docket administrator inputs the previously specified activity to the docket-entry creation window, and the previously specified activity is recognized by the billing, docketing and document program so that the appropriate docket template is retrieved. At step S635, the docket template is applied to the file to create new docket entries. As described above with respect to FIG. 5, application of the docket template to the file in S630 may require that the docket administrator determine and input specific date information such as the date an Office Action is issued. Once the docket template is applied to the file at step S630, the master docket is updated with the new docket entries at step S640.

Numerous actions may be triggered in the billing, docketing and document management system by the creation or handling of new docketing entries for a file. For instance, some actions may trigger automated “urgent” email alerts to one or more employees responsible for the associated file. These alerts may be, e.g., for instances where immediate action is required by the employee(s), such as when a communication is received that indicates defects in previous communications or correspondence for a file. Similarly, billing credit may be applied when an employee signs, enters or otherwise confirms an answer to a docketing entry. For example, each answer for a docketing entry that is confirmed may result in a credit of, e.g., 10 dollars, being applied to the file in the name of the employee who confirms the answer on the docket. Alternatively, each docketing entry that is confirmed may result in a credit of charges for, e.g., 1/10^{th} of an hour, being applied to the file in the name of the employee who confirms the answer on the docket. Moreover, confirmation of answers may result in the data for the file being applied to a document template to create a document and to a billing template to create a bill using the document management component and the billing component of the system. For example, confirmation that a required document was filed by entry of an answer to a docket entry may trigger generation of a reporting letter and a bill. Billing data from multiple sources, including timeslip programs that track timekeeper and event activity as well as activity monitors for facsimile, copy and phone system, will be pulled and applied to a billing template to create the draft bill. Client, docketing activity and file information will be applied to the billing template to populate fields in the draft bill being generated. Similarly, client, docketing activity and file information will be applied to a document template to populate fields in the draft document (e.g., letter, facsimile or email) being generated.

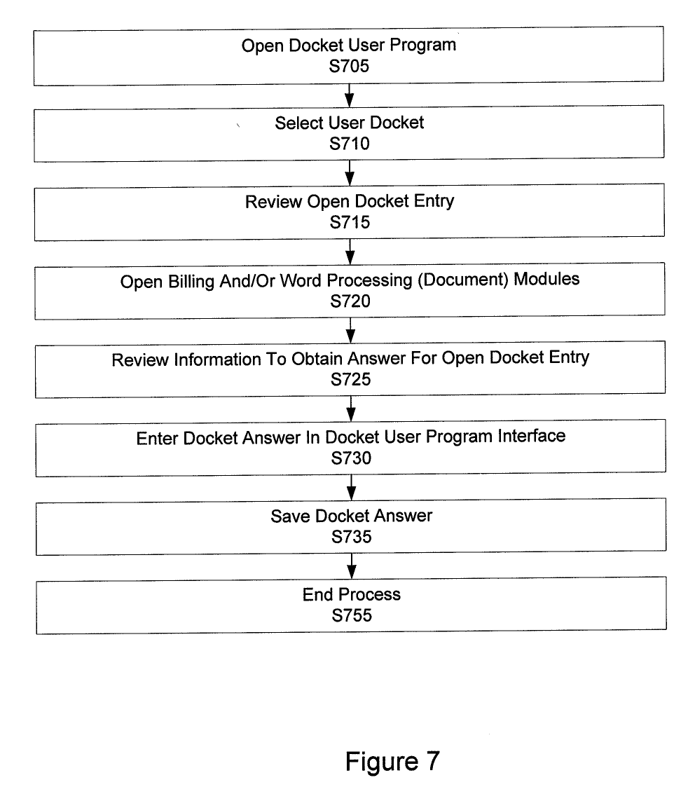

The addition of new docket template may automatically lead to different actions in the FIG. 7 is an exemplary method of answering docket entries in a master docket for billing, docketing and document management. FIG. 7 shows an exemplary method by which a user provides answers for docket entries to the billing, docketing and document management program. At step S705, the user opens the billing, docketing and document management program. The user selects and opens the daily docket portion of the master docket at step S710 to review the docket entries for which the user is responsible in the daily docket. The user locates and reviews an open (unanswered) docket entry in the daily docket at step S715. At step S720, the user opens a billing and/or word processing (document) module(s) to obtain information which can be used to properly answer the docket program. For example, a word processing (document) module may contain searchable records including images of incoming client instructions and/or filing receipts which indicate that a document was filed with the U.S. Patent and Trademark Office. At step S725, the user reviews the information in the billing and/or word processing (document) module, and at step S730 the user enters the answer to the docket entry into the user's docket program graphical user interface. At step S735 the docket answer is saved and the process ends at step S740.

Although not shown in FIG. 7, where the user in FIG. 7 is an administrative assistant and the answer to the docket entry requires approval and signature by an attorney, the saved answer will appear in the attorney's docket program on the attorney's computer. The attorney can verify the answer to the docket entry using the billing and/or word processing (document) module on the attorney's computer, and then approve and electronically sign the answer to the docket entry. The attorney then saves the electronic signature to the answer to the docket entry, and the signed answer to the docket entry then appears in the docket entry in the master docket or the daily docket of the master docket. The signed answer to the docket entry may further be reviewed and approved by a docket clerk on the docket clerk's computer, when a docket clerk is used to verify that all docket entries are answered properly for the intellectual property law firm described herein by way of example.

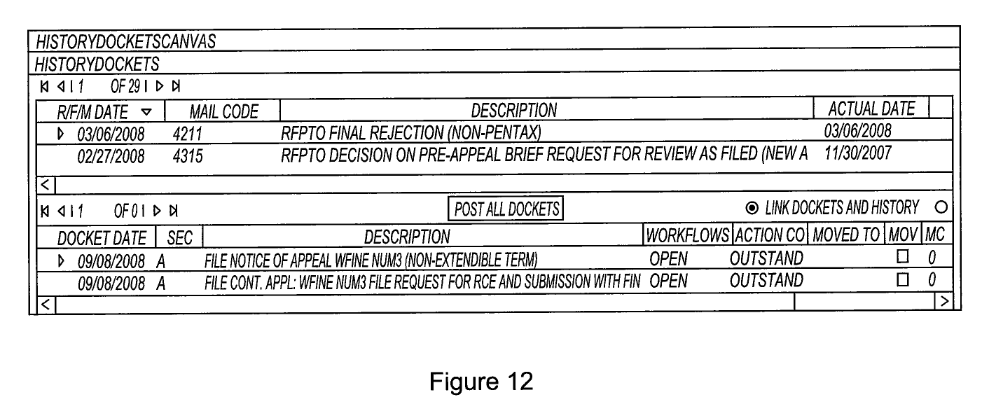

Information entered by a docketing clerk may also be accessed by the administrative assistant and/or attorney by clicking on the docketing entry in the daily docket or master docket. For example, FIG. 12 shows a partial screenshot of internal information that may be relevant to answering a docket entry. The exemplary intellectual property law firm may save a history of incoming and outgoing communications, including client instructions, communications to and from the U.S. Patent and Trademark Office, and reporting letters and bills sent to clients. In the example shown in FIG. 12, history information available by clicking on a docket entry shows that a final rejection was received on Mar. 6, 2008. In the parlance of an intellectual property law firm, this information could be used to confirm that a Response to a previous non-final rejection was filed, in that a final rejection could not be issued if a Response to a previous non-final rejection was not filed. The information shown in FIG. 12 is provided on a screen that includes other file information, including the client, the client's internal reference number for the file, and a summary of all outstanding docket entries for the file.

Additionally, when an answer is approved for a docket entry, the docketing module may automatically answer related docket entries. For example, when an answer to a docket entry to file a Response to a non-final Office Action by an initial due date is “filed”, the docketing module may automatically answer related docket entries to file a Response to the non-final Office Action with a one month extension of time and to file a Response to the non-final Office Action with a two month extension of time as “no need”. Related “reminder” docket entries may also be answered, so that the administrative assistant and attorney do not later have to exert an effort to answer these docket entries on the docketed date.

Further, when an administrative assistant is providing an answer to a docket entry, the administrative assistant may provide comments for review by the attorney when the attorney is to approve and sign the answer to the docket entry. Additionally, the administrative assistant may provide link information to link to a document accessible through the word processing (document) module. For example, where the intellectual property law firm stores documents through a central document management system, each stored document may be assigned a unique identifier. Such a unique identifier may be used to automatically link a document to a docket entry, so that the administrative assistant may enter the unique identifier in a comment field when preparing the answer, and the attorney may click on the unique identifier to access the stored document through the word processing (document) module when approving and signing the answer to the docket entry. As an example, the stored document may be an image of a filing receipt confirming that a document was filed with the U.S. Patent and Trademark Office.

Additionally, the screen on which docket entries are provided in the daily docket may also provide a drop-down selection of possible answers in the “action” column in which an answer for the docket entry is to be provided. Example answers to a docket entry for an intellectual property law firm include done, filed, filing, no need, move, inactive, night box and outstanding, and each of these answers may be selectable in the drop-down selection.

Once the answers are signed by the attorney and approved by a docketing clerk, the docket entry may be removed from the daily docket screen that is presented on the screens of some users including the assigned attorney and administrative assistant. However, the answered docket entry is stored on the master docket present managed by the application server 121 shown in FIG. 1. Further, some users assigned administrative or managerial roles may still be presented with docket entries with answered and approved signed answers, so that answers can be still further reviewed.

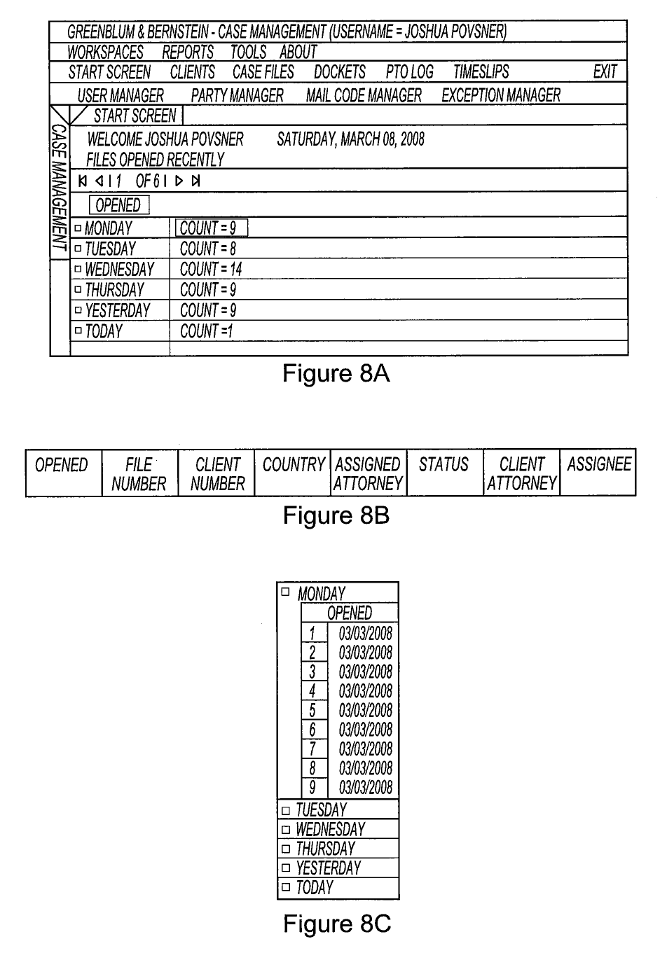

FIGS. 8A-8C are exemplary screenshots showing new file management information in a docketing program for billing, docketing and document management. The screen shot shown in FIG. 8A shows an unexpanded summary of files recently initially opened in the billing, docketing and document management system. In the screenshot of FIG. 8A, a column of six expandable rows summarizes the number of files recently initially opened for the six most recent days, including the day on which the screenshot is being viewed (e.g., a Saturday). FIG. 8B shows a row of column headers for information that is provided in the screen when a user clicks on any of the expandable rows. As shown, column headers are provided at the top of columns for the date opened, the internal file number of the file, a client identifier number, a filing country for the recently opened file, an assigned attorney, a file status, an attorney responsible for the client, and an assignee of the recently opened file. FIG. 8C shows an illustrated view of the right side of the screenshot shown in FIG. 8A, where the user clicks on the entry for Monday in FIG. 8A. As a result of clicking on the entry for Monday in FIG. 8A, the files opened on Monday are listed in column order, and the information corresponding to the column headers shown in 8B is provided in data fields for each file.

The screens shown in FIGS. 8A-8C may be components of a “Start” screen presented to users assigned roles as executive management or superusers when they first log in to the billing, docketing and document management program. Users assigned other roles may be presented other “Start” screens. For example, attorneys may be presented with a screen showing a filtered list of daily docket entries (i.e., for the day of the log in) for which the attorney is responsible. Docketing clerks, paralegals, and coordinators (supervisors for administrative assistants) may be presented with a screen showing a list of all daily docket entries for the day of the log in. Administrative assistants may be presented with a screen showing a filtered list of daily docket entries (i.e., for the day of the log in) for all attorneys for which the administrative assistant is responsible.

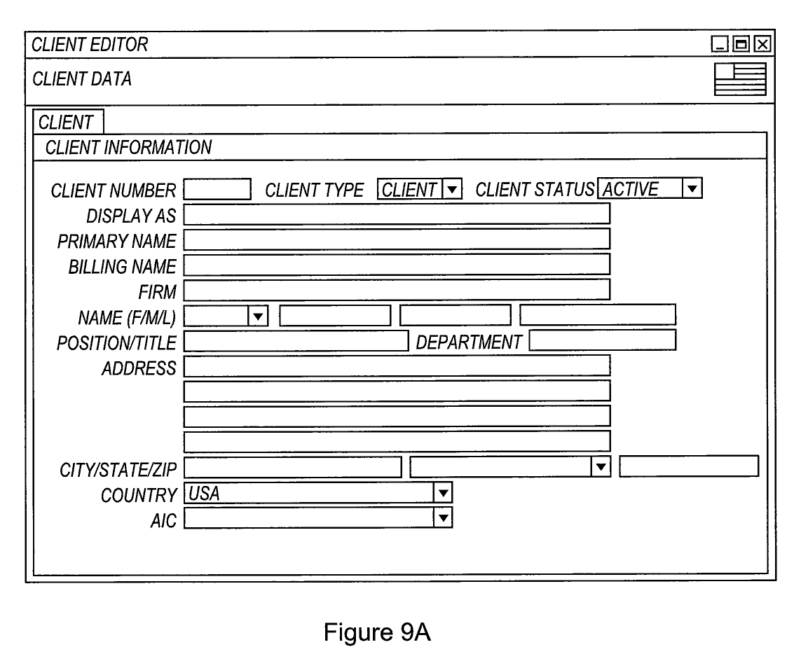

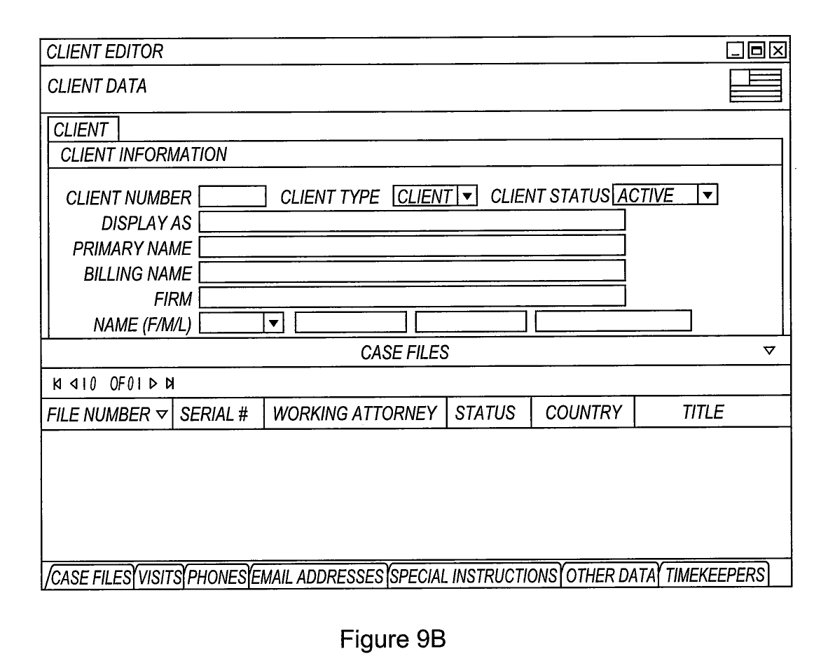

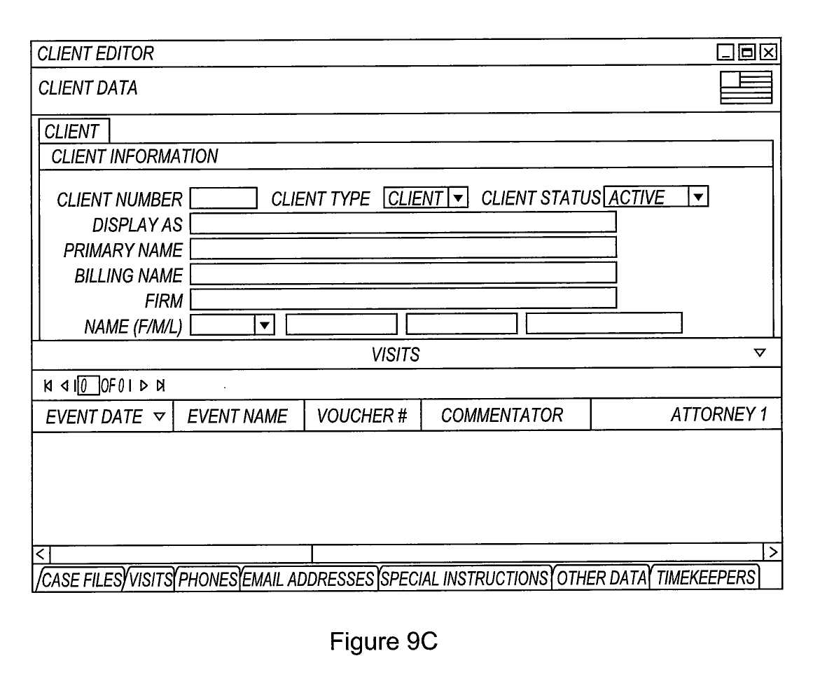

FIGS. 9A-9C are exemplary screenshots showing client management information in a docketing program for billing, docketing and document management. The screenshots of FIGS. 9A-9C are presented to a user assigned as an administrative role to enter new clients into the billing, docketing and document management program. As shown in FIG. 9A, information such as contact name, firm name, billing name, and address are presented to the administrator on a screen. FIGS. 9B and 9C show information associated with a client, such as files opened for the client and information for visits by representatives of the client. The case files information in FIG. 9B and visit information shown in FIG. 9C may be presented to the administrator as pop up information when the administrator clicks on a tab on the screen shown in FIG. 9A, or when the administrator drags a cursor over a tab on the screen shown in FIG. 9A.

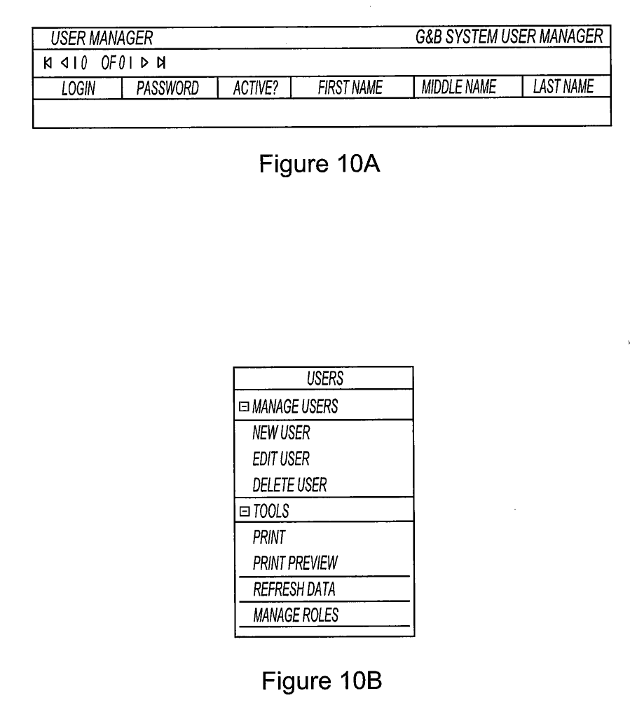

FIGS. 10A and 10B show exemplary screenshots showing user management information in a docketing program for billing, docketing and document management. As shown in FIG. 10A, an administrator responsible for entering user information into the billing, docketing and document management system types a login identification, a name and a system password into a row of fields provided on the screen. FIG. 10B shows that the responsible administrator can enter new users, or edit or existing users in the billing, docketing and document management program.

FIGS. 11A-11B show exemplary screenshots showing unique system identifiers called mail codes which are associated in the system specified activities, and a docket template triggered by specified activity information in a docketing program for billing, docketing and document management. Mail codes are unique system identifiers which are logically arranged in a hierarchy starting with default values. A mail code is used by the docket administrator to generate the docket template upon recognition of the specified activity. However, exceptions to default values may be provided for specified clients and files requiring docket entries other than the default docket entries of the default docket template corresponding to a specified mail code. For example, if a docket administrator inputs a default mail code for a docket template corresponding to “filed executed patent application based on provisional patent application” (i.e., the highlighted specified activity shown in FIG. 11B), than the default docket template shown in FIG. 11B is generated. However, when applying a docket template to a file, the billing, docketing and document program may recognize that a client identifier input by the docket administrator corresponds to an exception to the default docket template for the default mail code input by the docket administrator. Accordingly, the billing, docketing and document program will generate the exception docket template and not the default docket template, and the customized exception docket template will be applied to the file to which new docket entries are applied.

In the screens shown in FIGS. 11A and 11B, a docket administrator can invoke a “copy” function to copy a mail code so as to generate a new docket template. Of course, a docket administrator can also create a new mail code and docket template without copying a previously generated docket template.

Further, mail codes may be used to automatically generate bills using the billing module linked to the docket module. For example, when the docket administrator uses a docket template to create new docket entries upon filing a document in the U.S. Patent and Trademark Office, the action of the billing, docketing and document management program may automatically compile timeslips entered by timekeepers as well as administrative expenses and government fees, and generate a draft bill for review by users of the billing, docketing and document management program. Similar to the docket entries generated based on a docket template, the automatically-generated draft bill is generated based upon a bill template. A bill template may be a default bill template for a default mail code, or may be an exception bill template for an exception mail code.

Additionally, mail codes may be used to automatically generate documents using the word processing (document) module linked to the docket module. For example, when the docket administrator uses a docket template to create new docket entries upon filing a document in the U.S. Patent and Trademark Office, the action of the billing, docketing and document management program may automatically generate a draft reporting letter for review by users of the billing, docketing and document management program. Similar to the docket entries generated based on a docket template, the automatically-generated draft reporting letter is generated based upon a reporting letter template. A reporting letter template may be a default reporting letter template for a default mail code, or may be an exception reporting letter template for an exception mail code.

As described above, docket entries may be created from template sets or as individual entries. Information useful for answering docket entries can be searched and linked in a billing, docketing and document program. Administrative assistants can prepare answers using the searched and linked information, and attorneys can review, approve and electronically sign docket entries by referencing comments and linked information provided by administrative assistants.

Users of the billing, docketing and document program can also “filter” daily dockets according to predetermined criteria using filter functions. Pressing a filter icon provided at the top of a daily docket screen results in activation of the filter function. The filter function allows a user to input information to filter the daily dockets in accordance with data of any of the information fields shown in, e.g., daily docket entries. The user may input information to be used in logical comparisons with the data of the fields in each docket entry of the daily docket. For example, the logical comparisons may include “equals”, “does not equal”, “less than”, “less than or equal to”, “greater than”, “greater than or equal to”, “like”, “starts with”, “contains”, “ends with”, “does not start with”, “does not contain”, “greater than”, “greater than or equal to”, “like” or any other logical comparison that can be made with data of the fields in each docket entry.

Some or all filter criteria may also be set by using an “edit query” link button on a docketing interface to call up an interface for retrieving specified docket entries. The interface for retrieving specified docket entries may allow the user to specify a start date and end date for docketing entries to be retrieved. The interface for retrieving specified docket entries may allow the user to specify which user dockets are to be retrieved, ranging from the user docket for the user interacting with the interface to all users dockets for all users in the system. The interface for retrieving specified docket entries may also allow the user to specify the priority of docket entries to be retrieved, ranging from the highest or lowest priority docket entries to all docket priorities of any priority. As an example of the use of this functionality, a supervisor could call up a range of docket entries for an underling according to date and priority, and check the status of items to be completed by reviewing the status indicated for each docket entry.

Docket entries are presented in the docket table in accordance with criteria set in the “edit query” interface. The entries in the docket table may then also be filtered using a “filter” link on the docketing interface to invoke data entry fields for each docket parameter to specify values for any or all docket parameters. For example, when a user retrieves the user dockets for all users in the system, the user interacting with the docket table may filter the entries by filtering a “client” docket parameter so that only docket entries for a particular client are shown. The entries may further be filtered by selecting docket parameters by priority, by user, by authorized signer who has signed a docket answer, by authorized requester who has requested presentation of a docket answer, by a particular type of docket entry using a selection of words such as “Heard From Client”, or by file. As an example of the use of this functionality, a user could review all outstanding docket entries for a particular file for the next 6 months, and then attempt to answer any or all outstanding docket entries for the file which are set to be answered in the next 6 months. Thus, a user can review all docket entries to be answered for a file, and answer all such docket entries at one time rather than piecemeal as answers to the docket entries become due.

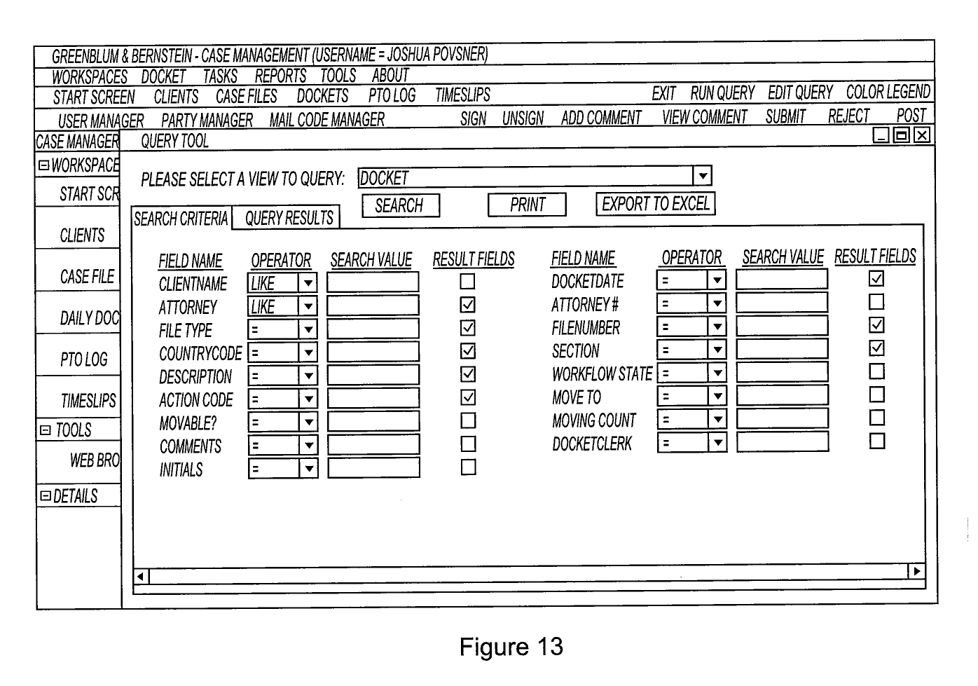

Other functions similar to the “filter” functionality may be provided. For example, a “toggle” function may arrange the docket entries of a master docket in order of attorney and date. Similarly, a “query” tool may be used to generate a screen with which a user can search for docket entries. An example of a pop-up query tool screen that is provided to a user upon pressing a “run query” icon on a daily docket screen is shown in FIG. 13. As shown, the pop-up query tool allows a user to enter data for any of docket entry daily fields, so that docket entries can be returned in accordance with the user's input. This “query” tool is used in the event that a large number of docket entries are present in a daily docket or master docket presented to the user.

User group functions may also be provide by the billing, docketing and document management program. As an example, if a group of employees are dedicated to assembling outgoing documents for filing at the U.S. Patent and Trademark Office, a “filing” log can be used to produce a filing log of all docket entries answered as “filing” by an attorney. The “filing” log can then be reviewed to ensure that all documents that are supposed to be filed are, in fact, filed.

As described above, docket information in a shared environment can be provided to multiple different server clients in accordance with multiple different user roles and access authorizations. Docket entries can be processed using a billing, docket and document program so that multiple users may all be aware of the status of answers to docket entries, and so that docket entries can be presented by priority, status or any of the other docket entry fields present for docket entries. Answers to one docket entry can be used to automatically update answers for related docket entries, and users can be easily informed of upcoming docket entries for which an answer is required. Moreover, addition of new docket entries can be used to automatically answer previous docket entries for a file. For example, addition of new docket entries for responding to a newly-received Office Action for a file from the U.S. Patent and Trademark Office may result in automatically answering previous docket entries in the docket table of “New Action Received” for the file.

Further, the multiple user roles allow multiple levels of verification and review, so that managers and coordinators can review the performance of multiple users, and so that a docketing clerk can review a daily docket to ensure that all docket entries for the daily docket are properly answered. Attorneys can therefore provide answers to docket entries using the billing, docket and document program even before the date on which an answer is due for the docket entry. Managers can also quickly retrieve and review unanswered docket entries so that patterns of unanswered docket entries can be addressed by, e.g., reassigning responsibilities between employees, reducing or increasing workload for employees, or encouraging employees to meet work requirements such that the docket entries can be answered satisfactorily.

A document management system may also be integrated with the docketing management system described herein. For example, a document management system may log different documents saved by employees in accordance with file numbers, client numbers, author, typist, practice type and document type. Documents may be indexed by the document management system so that each document is assigned a unique identification such as a sequential document creation number. The document management system may record the date on which the document is created as well as the dates on which the document is modified. Users of the document management system may add a name or comment to a profile of each document. Documents may be text searchable so that one or more databases on which documents are stored may be searched by users.

Document templates may be created and managed by the document management system in a way so that a document template can be automatically retrieved and used as the basis for a new document when a predefined action occurs in the docketing management system. For example, in the example of an intellectual property law firm, addition of a docket entry indicating that a document was filed with the U.S. Patent and Trademark Office may automatically lead to creation of a reporting letter, based on a reporting letter template, to report the document filing to the client for the file for which the document was filed. Similarly, entry of an answer to a docket entry confirming that a document was filed with the U.S. Patent and Trademark Office may automatically lead to creation of the reporting letter, based on the reporting letter template, to report the document filing to the client for the file for which the document was filed.

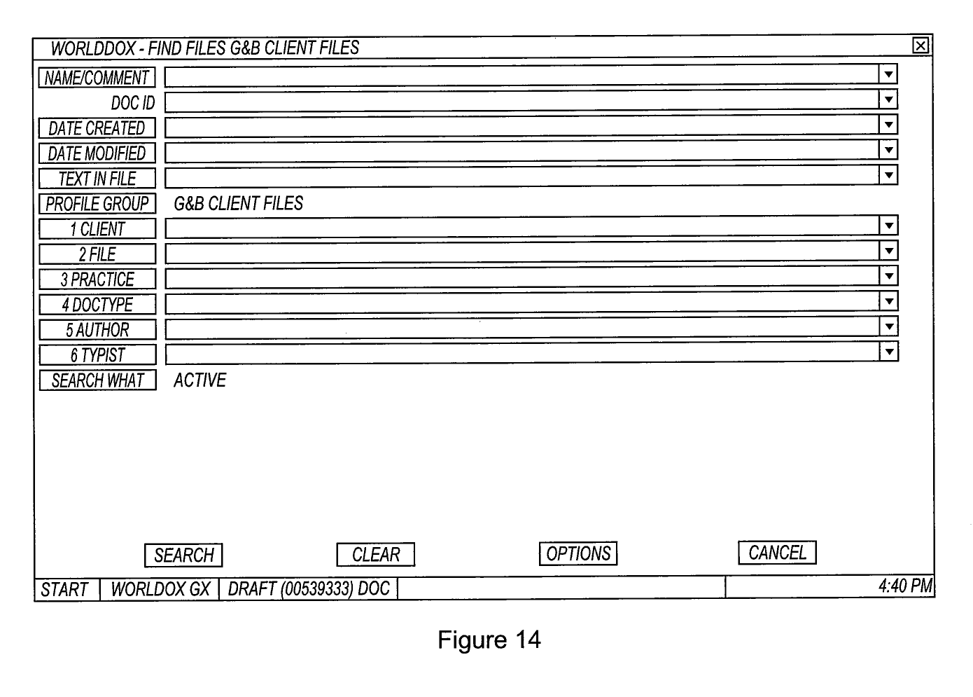

FIG. 14 shows an exemplary screenshot showing a pop-up query window for a user to retrieve documents using a document management system. In the screenshot shown in FIG. 14, entry fields for document search parameters include name/comment, document identification, date created, date modified, text in file, client, file, practice, document type, author and typist. A user may enter data into one or more of the search parameter fields shown in FIG. 14 to retrieve documents once created and profiled/indexed by the document management system. A separate pup-up window may be provided for users to enter the search parameter information when a document is initially created or saved.

The docketing management system and document management system each refer to the same set of underlying file data to organize docketing entries, docketing answers and documents. Thus, for a docketing administrator to create a set of docketing entries for a particular file based on a docketing template, the docketing administrator needs merely to specify the file number, the underlying event for which the set of docketing entries are created, and the date of the underlying event for which the set of docketing entries are created. From the time the file is initially opened, underlying data for the file can be stored as a profile of the file. The underlying data for the profile of a file includes file number, client identifier, title, and client reference number, and can be supplemented with additional information over time, including patent application number, patent publication number and patent number.

Clients are also profiled so that a client identifier is associated with underlying client data from the time a client is first entered into the system. Underlying client data may include client identifier, client address and phone/facsimile number, and an individual contact for a client entity. Because the underlying data for the profile of a file includes the client identifier, the additionally underlying client data is inherently linked to or present in file data for each individual file from a client.

Document templates can be created both as defaults and as tailored document templates for individual clients. Different document templates are created for different types of documents. For example, document templates may be created for reporting information to clients. Different reporting templates may be created for filing patent applications, filing information disclosure statements, filing amendments to Office Actions, filing appeal briefs, filing reply briefs, receiving Office Actions, receiving examiner's answers, receiving official filing receipts for patent applications, and filing any other types of documents with the U.S. Patent and Trademark Office or receiving any other types of documents from the U.S. Patent and Trademark Office.

Document templates can be customized for different communication modes, including email, letter and facsimile. Thus, different client address information may be entered into a new document when the new document is automatically created. For example, a client email address may be added to an email for the client, a client facsimile number may be added to a facsimile for the client, and a client post office address may be added to a letter for the client.

File identification information is also entered for each document. For example, a letter or facsimile reporting receipt of a communication from the U.S. Patent and Trademark Office may include the application number, the title, the name of a first listed inventor, a client reference number, and the file identifier. This file identification information is placed in a “Re:” line on the newly created letter or facsimile. This file identification information is placed in a “subject” line on a newly created email.

The content of the communication may also be customized for each client by linking the “action” dates set in the docketing management system to predetermined fields in the document template. For example, where an Office Action is issued on a January 1^{st} and an extendible initial due date for Response is April 1^{st}, the communication reporting the Office Action will automatically indicate that the Office Action was issued on January 1^{st} and the extendible initial due date for Response is April 1^{st}. The document template upon which the reporting communication is based includes links that are updated based on the docket entry due dates set in the docketing management system.

Therefore, when the docket entry set for responding to an Office Action is entered in the docketing management system for a file, the docketing management system automatically notifies the document management system to open a new reporting communication document for the file. The file is opened, and file information including client address information, file identifier, client file reference number, file title, and inventor name are retrieved from the profile for the file and used to fill in the relevant information for the newly-opened file. Docket entry data such as Office Action issue date and initial and inextendible due dates are then used to fill in variable information that depends on the docket entries.

Docket entries can also be grouped into customized presentations. For example, entries for an intellectual property law firm may be answered “filing” when documents are to be filed with the U.S. Patent and Trademark Office. All documents answered “filing” may be grouped on a “filing manager's log” so that an appointed filing manager can track a customized presentation that includes all entries answered as “filing” on a particular day. The “filing manager's log” may be available to all employees of the intellectual property law firm, so that all employees, including managers and administrators, can track and update the documents to be filed each day and thereby ensure that the documents are filed. The customized presentation for a “filing manager's log” may include only those entries due on a particular day and answered as “filing”. Alternatively, the customized presentation for a “filing manager's log” may include those entries due on the current day and any future day and answered as “filing”. The customized presentation may be presented to users as a window on a computer, and the window may be presented to the users when the users collect a link made available on one or more other windows presented by the docketing management system.

The use of mail codes can be used as a basis for generating docketing templates using the docketing management system, and for generating documents based on document templates using the document management system. A mail code is an action identifier that may be provided as a customized basis for generating a docketing entry set and one or more documents based on document templates. The mail codes correspond to a predetermined docket entry set and the one or more documents, and are used to activate software codes to generate the predetermined docket entry set and the one or more documents. As an example, a mail code “5566” may be used as a default mail code for receipt of an Office Action from the U.S. Patent and Trademark Office, and may be used to apply a template of docket entries to the file for which the Office Action is received. The docket entries may include entries for reporting the Office Action to the client in 7 days, and for responding to the Office Action 3 months, 4 months, 5 months and 6 months from the date of the Office Action. A different mail code “5567” may be used for a particular client, and may be used to apply a template of docket entries to the file where the template is customized for the client. As an example, the customized template may include a docket entry for reporting the Office Action to the client in 3 days rather than 7 days as with the default docket template.

The mail codes may also be used to activate software codes to generate the one or more documents for reporting the Office Action to the client and for responding to the Office Action. As an example, the mail code “5566” may be used as a default mail code to generate a reporting letter to a client, where the corresponding information from the docketing management system is used to populate fields in the document for client address, the file information for the document, and date of the Office Action and due dates. Thus, metadata in the document template is populated with the information from the docketing management system for the field, and the document is automatically created and saved in the document management system and indexed (profiled) under the file number for the file for which the Office Action was received. A customized document template may similarly be populated when the mail code “5567” is applied to the file. Other mail codes may be used later to generate additional reporting documents once a response to the Office Action is filed, to confirm filing the response to the client.

The mail codes may be determined, approved and applied by a docketing administrator to apply the docketing template and to generate documents based on templates. As an example, the docketing administrator may determine, approve and apply a mail code upon receipt of a document or other information from the U.S. Patent and Trademark Office, or upon confirmation that a document or other information was filed in the U.S. Patent and Trademark Office. In an embodiment, once a docket entry is approved for entry to the master docket, the docketing administrator may select the docket entry on the master docket and hit a “print” icon in order to obtain an option for preparing the letter, facsimile or email by applying the docketing management system information to the predetermined metadata fields of a docket template. In another embodiment, any user of the docketing management system may be allowed to generate a linked document in the document management system by selecting a docket entry and hitting a “print” icon in order to obtain the option for preparing the letter, facsimile or email.

Alternatively, a separate programming module may be used to facilitate generating documents. A user may open a “word processing menu” programming module, and select an action item to generate a document as an email, facsimile or letter. The menu may also give several options for selecting a recipient when several recipients are possible for a file. For example, when coordinating communications between clients and foreign attorneys responsible for corresponding foreign files, the user may need to select a recipient as one of the underlying client and the foreign attorneys.

The docketing management system may also be used to determine potential conflicts among clients for the intellectual property law firm. As an example, the docketing information obtained and input to the docketing management system may include inventor names, invention titles, assignee names, and invention abstract summaries to summarize the subject matter of different files. Using these different types of information, a user may search for potentially conflicting files at the time a new file is received from a client. Potential conflicts can be then identified using, e.g., code words to search for similar code words in abstract of all files handled by the intellectual property law firm, or for similar code words in titles of all files handled by the intellectual property law firm. A conflict programming module may also be used to link to and search through online files made available via the internet by the U.S. Patent and Trademark Office.

A billing management system may also be integrated with the docketing management system and the document management system. As an initial matter, a benefit of such integration may be that billing credits are recorded in the billing management system for activities completed using the docketing management system and the document management system. Thus, for example, entry and acceptance of a final answer for a docket entry may result in automatic credit to the signer of the docket entry of a flat charge to clients for reviewing and answering docket answers. This is accomplished when the answer to the docket entry posts (i.e., is finally accepted) by the docketing management system, whereby the docketing management system forwards a notification to the billing management system that the attorney signing the answer to the docket entry has signed a final answer to the docket entry. Thus, the file number and attorney (in the example of an intellectual property law firm) information are forwarded to the billing management system, and a charge is recorded by the billing management system for the file and attorney.

Professional service timeslip entries may be entered as a main entry, a grid entry, a docketing auto-option, or a batch entry. A main entry is a single timeslip entry, whereby professional service time can be entered by date, file, timekeeper, stage, rate, increment in hours, and description/comment. A grid entry is a grid of main entries for two or more main entries, whereby multiple professional service timeslips can be entered for a timekeeper by date, file, stage, increment in hours, and description/comment. The docketing auto-option is the mechanism described above, whereby a timekeeper is credited with a flat fee or predetermined amount for finally answering a docket entry. A batch entry allows a timekeeper to enter the same time and description for multiple files at once, such as for reviewing and signing a series of similar facsimile or letters.

The selection of stage by a timekeeper when entering time is used to associate the timeslip entry with a mail code for the file, so that recorded time can later be grouped when generating billing information for the file. Thus, the billing management system uses the same mail code as the docketing management system and document management system, where the mail code is used to generate a docketing template to apply to a file, to generate documents for reporting or responding as appropriate for whatever action has led to the docketing template being applied to the file, and to associate professional service timeslips with addressing whatever action has led to the docketing template being applied to the file. Of course, timeslips may be entered even when corresponding docketing entries are not open for the file, in which case the timeslips are still associated with the appropriate mail code for later collection and presentation in a bill to the client.

Bills are presented to clients using the same file information as used by the docketing management system and document management system. Thus, bills may be presented using the same header information as would be used in a letter or facsimile. Bills are generated by applying billing information to a billing template for the file. Thus, a summary of all previously unbilled time entered by all timekeepers for the file in a time period may be added to a bill sequentially in association with the timekeeper name, incremental hours and comments (or an editorialized version of the comments), by applying an instruction to generate a bill for the client.

Clients may instruct the intellectual property law firm to predefined billing codes for different types of activities, so that different activities are ultimately presented to clients under common predefined descriptions. Thus, any activity undertaken in reviewing an Office Action and preparing a response to the Office Action may be associated with a particular billing code regardless of the timekeeper's description of the activity.

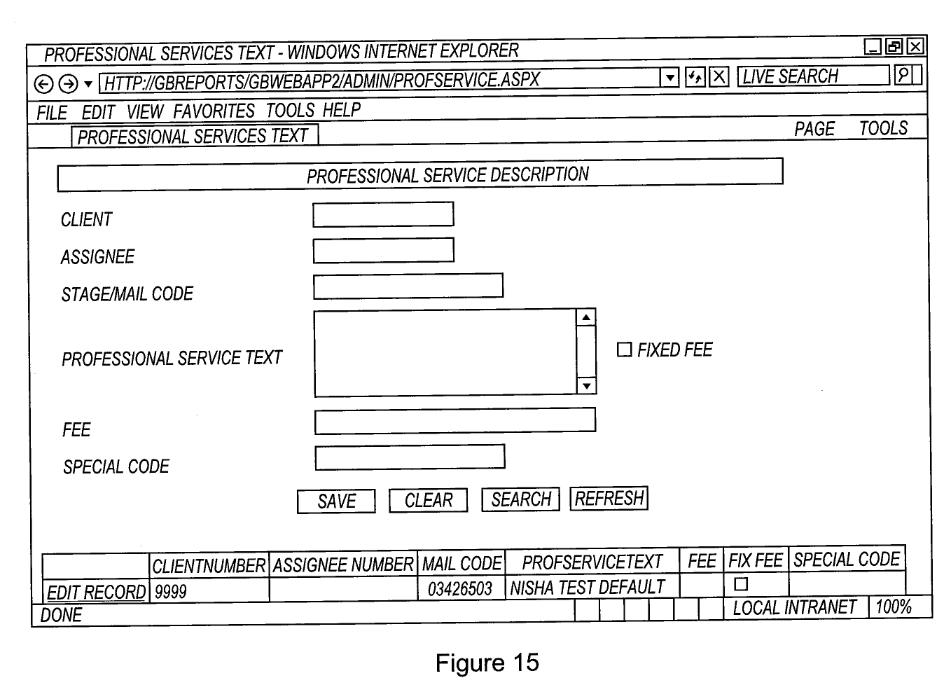

Alternatively, a predetermined narrative may be entered for describing specified activities in a bill to a client, so that only a total charge is indicated to the client for all of the timeslips entered by timekeepers for the specified activities. FIG. 15 is an exemplary screenshot showing a window for entering professional service information into a bill using a billing management system. In the screenshot of FIG. 15, an administrator is allowed to create a template of professional service description for a predetermined stage or mail code for a specified client. A checkbox is also provided in FIG. 15 for the administrator to indicate that the fees for the professional services are fixed, and to enter the fixed fee if appropriate. Therefore, rates and fees can be customized in a billing management system for different clients, and even for individual files. As an example, the intellectual property law firm may set a fixed professional service fee of $120.00 for filing a 1 month extension of time for responding to any action or requirement from the U.S. Patent and Trademark Office.

Disbursements such as expenses incurred by the intellectual property law firm can also be preset and customized as defaults and for individual clients and individual files. As an example, different copy charges or facsimile charges per page can be set for different clients in accordance with client demands. Copy and facsimile machines may be networked into the billing management system, so that numbers of copies and facsimiles may be recorded by file and date. The copy and facsimile data may be retrieved and presented when a bill is generated. Such expense data may also be hand-entered data for services from outside service providers such as draftsmen and translators. Therefore, merely by applying one or more mail codes to a file in a billing management system, a bill can be generated to present outstanding charges to a client, and professional services recorded for activities corresponding to the one or more mail codes can be grouped individually under specific headings in accordance with client requirements. Other professional services recorded for activities that do not correspond to the one or more mail codes can be individually listed on the bill, and grouped or otherwise edited later when the bill is edited and finalized.

As described above, bills may be generated in predetermined formats set up by administrators. A billing rules table allows an administrator to create billing templates for clients, so that bills can be customized for clients, assignees and even individual files. The administrator can specify whether the bills are to be itemized for each professional service fee, or summarized using predetermined descriptions for specified activities. The administrator can also specify whether the bills are to be itemized for individual disbursements, or whether some or all disbursement fees are to be cancelled as part of a fixed fee arrangement.

Thus, when a bill is to be generated using the billing management system, the bill will include the same client data as the client data used by the document management system as entered in the docketing management system. Further, the bill will include charges customized in accordance with client agreements, including flat fees and variable or cancelled disbursement charges. Moreover, the bill will include charges automatically generated based on timekeeper interaction with the docketing management system or the document management system, so that docket entry final answers will lead to presentation of charges to clients.

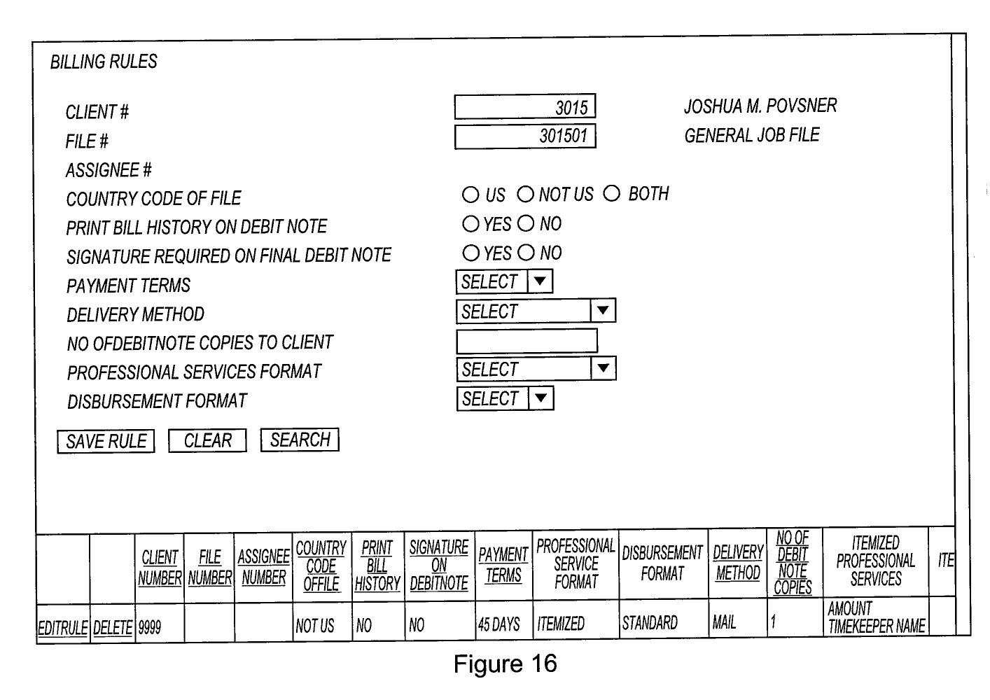

FIG. 16 is an exemplary screenshot showing a window for entering global billing rules for preparing and presenting bills to clients. As shown, a billing administrator can enter global billing rules for preparing and presenting bills by client identifier and file number. The billing administrator can also specify an assignee and country code for bill preparation and presentation. Rules can be selected for printing a bill history on a debit note, and requiring a signature on any copy of a debit note to be presented to the client. Payment terms may be selected from a drop down window. Delivery method for bill presentation can also be selected from a drop down window. As an example, a client may specify that bills are to be uploaded as an image file to a client website, and the billing administrator can specify these instructions when entering the billing rules for the client. The billing administrator can also specify the number of debit note copies to present to the client, as well as the professional services format, and the disbursement formats to use in the debit notes for the client. Examples of selections used to generate a rule are shown at the bottom of page 16.

As explained above, an integrated billing, docketing and document management system is provided. From a management perspective, a manager can view all docketing entries for an entire business for a current day, a future day, a specified time period or any other time metric. The manager can view types of docketing entries by priority, by file number, by the person responsible for files for which docketing entries are set, by the number of times an entry answer has been moved, by the docket answer, or by the workflow state (i.e., “open”, “posted” or “under review”). A manager can review work performed or not performed by various employees, and can review work balances to ensure work is evenly distributed among employees. The manager can also review docket answers to see which employees are behind or ahead of scheduled work.

The integration of word processing and billing systems with a docketing system allows a manager to review documents associated (linked) with specified docket entries, to ensure the documents have been properly prepared. Docket answers can be linked to documents in a document management system, so that any or all employees can click on a link to retrieve and open a document for review to verify the accuracy of the docket answer.

Thus, work flow for a business can be managed at all levels, and managers can review work performance and redirect employee efforts dynamically. The integrated billing, document and docketing management systems allow for work flow monitoring on demand in an office environment, so that a manager can see what is done and not done. Because the data may be made available to all interested employees, individual communications between employees are reduced. In the example of an intellectual property law firm, attorneys are therefore able to spend more time focusing on professional work rather than administrative work. Administrative assistant satisfaction is also improved, as administrative assistants are provided access to all necessary information needed to complete administrative tasks. The system may result in reduced overtime expenses, and less dependency on the availability of others.

Billing is also better managed using the integrated systems. For example, physical movement of files around an office in preparing a bill is reduced. As bills can be more efficiently prepared and presented, cash flow may be improved both in speed and consistency. The improved speed in presenting bills results, in turn, may result in a reduction in accounts receivable. Of course, any or all information necessary to verify the accuracy of bills may be made accessible via the docketing and document management systems.

Additionally, a manager can review allocations of time using the billing management system. For example, a manager can review time by any or all of time keeper, file, date, period, employee group or client. Managers can review subordinates to ensure that subordinates are performing all required work, and enough work to ensure continued employment.

The integrated personnel management system described herein thus includes at least one tangible data storage that stores bill templates, docketing templates and document templates that differ for different clients. The tangible data storage stores rules for generating the bill templates, docketing templates and document templates. The templates may be created and customized for individual clients and tasks. Thus, a template for a letter or facsimile or bill for a particular task for one client may differ from a template for a similar letter or facsimile or bill for the same particular task for another client.

At least one computer processor in the system generates bills, dockets and documents based on the stored rules, the bill templates, the docketing templates and the document templates. Different processors may be used for generation of bills and dockets and documents. However, in the event that different processors are used for bills and dockets and documents, the different processors either operate as clients in a client-server network or as peers in a peer-to-peer network, such that the operations of the different processors are integrated. That is, the billing, docketing and document management system described herein may be integrated so that entry of data to the docketing component of the system can be used to automatically generate bills using the billing component of the system and documents using the document component of the system.

At least one physical display in the system displays the bills, dockets and documents. Typically, each processor in the system would be associated with at least one, and possibly more than one, display such as a monitor to view templates or bills, dockets and documents.

Status of the bills, dockets and documents assigned to multiple personnel can be obtained and centrally monitored from generation to completion by one or more management personnel. Indeed, different users may be given different “views” of the data, such that some workers are presented information only that is within their responsibility. Thus, access and control over data may be granted in accordance with the management hierarchy of an organization.

Docketing templates for specified activities are created based upon administrative information collected at a client computer that includes one of the at least one computer processors. Docketing templates are generated for specified files upon determination of occurrence of specified activities at a client computer that includes one of the at least one computer processors. Docket entries based on the docketing template are presented at a client computer that includes one of the at least one computer processors on a docket for a day on which the docket entries require answers. Proposed answers to the docket entries of the docketing template are presented at a client computer that includes one of the at least one computer processors on the docket for the day on which the docket entries require answers.

A server computer processor in the system generates a master docket for the multiple personnel. The master docket is the entirety of docket entries for all personnel within the purview of the system, and includes all docket entries for all days in the system. Therefore, docket entries can be reviewed and answered in advance, even far in advance, using the system described herein. Personnel with different responsibilities, and different levels of responsibilities, may view bill, docket and document data tailored to their responsibilities and different levels of responsibilities.

The master docket includes docket entries for files of different clients. The master docket includes docket entries assigned to multiple personnel for answers. Different portions of the master docket are presented to different personnel based upon assignment of responsibilities for answering different docket entries. Access to docket entries for the different portions of the master docket is granted to the different personnel based upon the rules.

Ability to answer and sign answers to docket entries for the different portions of the master docket is granted to the different personnel based upon the rules. Documents are automatically created based on the document templates and rules upon occurrence of predetermined specified activities. Bills are automatically created based on the billing templates and rules upon occurrence of predetermined specified activities. The documents and bills are automatically created based upon the same predetermined specified activities.

Billing data for bills includes time charges for individual timekeepers with specified rates per hour, and flat charges for individual activities. The flat charges for individual activities vary by client. Billing data for bills further includes accumulated administrative costs on a per page basis. Billing data for bills further includes accumulated administrative costs on a per minute basis. Billing data for bills also includes accumulated administrative costs on a per instance basis.

Using the system described herein, different software programs for billing, docketing and document management are integrated together such that input of information using one of the billing, docketing and document management software programs results in automatic generation by one of the at least one computer processor of bills or dockets or documents using the other two of the billing, docketing and document management software programs.

As described above, a customizable system for billing, docketing and document management allows an administrator to customize bill, docket and document templates in accordance with different client, file and/or activity instructions and guidelines. Such bill, docket and document templates can be generated for bills, docket entries and documents in accordance with appropriate billing arrangements and client policies and requirements, and thereby avoid a need to manually draft different bills, dockets and documents for different clients, files and/or activity instructions and guidelines. The bill, docket and document templates can be applied for individual files to create bills, docket entries, and documents as used in the normal course of business by the intellectual property law firm. Thus, for a business with numerous deadlines and different client agreements for similar services, bills, docket entries, and documents can be customized in accordance with agreements with the clients.

The customizable system for billing, docketing and document management is applicable to environments other than intellectual property law firms. For example, human resources departments in many entities are subject to reporting deadlines for new hires and departing employees. Deadlines for activities can be set in a docketing management system, and document templates can be partially or fully populated with data from the docketing management system. For example, an employee identification number may be considered the equivalent of a file identifier for an employee, and the employee's address may be considered the equivalent of a client address. The employee start or departure dates as entered into a docketing management system can then be used with the employee identification number and associated information to populate document fields for reporting the hire or departure to a state employee commission or a retirement account manager.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

In accordance with various embodiments of the present invention, the methods described herein are intended for operation as software programs run by a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are recorded and stored on one or more tangible storage mediums. Tangible storage mediums include portable tangible mediums, such as disks or tapes, or magneto-optical or optical mediums such as disks; or solid state mediums such as memory cards or other packages that house one or more read-only (non-volatile) memories, random access memories, or other re-writable (volatile) memories. Accordingly, the invention is considered to include a tangible storage medium, as listed herein and including art-recognized equivalents and successor media, in and on which the software implementations herein are recorded and stored.

What is claimed is:

1. An integrated personnel management system, comprising:
at least one tangible data storage that stores bill templates, docketing templates and document templates that differ for different clients, and that stores rules for generating the bill templates, docketing templates and document templates;
at least one computer processor that generates bills, dockets and documents based on the stored rules, the bill templates, the docketing templates and the document templates, and
at least one physical display that displays the bills, dockets and documents,
wherein status of the bills, dockets and documents assigned to multiple personnel can be obtained and centrally monitored from generation to completion.

2. The integrated personnel management system of claim 1,
wherein docketing templates for specified activities are created based upon administrative information collected at a client computer that includes one of the at least one computer processors.

3. The integrated personnel management system of claim 1,
wherein docketing templates are generated for specified files upon determination of occurrence of specified activities at a client computer that includes one of the at least one computer processors.

4. The integrated personnel management system of claim 1,
wherein docket entries based on the docketing template are presented at a client computer that includes one of the at least one computer processors on a docket for a day on which the docket entries require answers.

5. The integrated personnel management system of claim 4,
wherein proposed answers to the docket entries of the docketing template are presented at a client computer that includes one of the at least one computer processors on the docket for the day on which the docket entries require answers.

6. The integrated personnel management system of claim 1, further comprising:
a server computer processor that generates a master docket for the multiple personnel.

7. The integrated personnel management system of claim 6,
wherein the master docket includes docket entries for files of different clients.

8. The integrated personnel management system of claim 7,
wherein the master docket includes docket entries assigned to multiple personnel for answers.

9. The integrated personnel management system of claim 8,
wherein different portions of the master docket are presented to different personnel based upon assignment of responsibilities for answering different docket entries.

10. The integrated personnel management system of claim 9,
wherein access to docket entries for the different portions of the master docket is granted to the different personnel based upon the rules.

11. The integrated personnel management system of claim 10,
wherein ability to answer and sign answers to docket entries for the different portions of the master docket is granted to the different personnel based upon the rules.

12. The integrated personnel management system of claim 1,
wherein documents are automatically created based on the document templates and rules upon occurrence of predetermined specified activities.

13. The integrated personnel management system of claim 1,
wherein bills are automatically created based on the billing templates and rules upon occurrence of predetermined specified activities.

14. The integrated personnel management system of claim 1,
wherein documents are automatically created based on the document templates and rules upon occurrence of predetermined specified activities;
wherein bills are automatically created based on the billing templates and rules upon occurrence of predetermined specified activities, and
wherein the documents and bills are automatically created based upon the same predetermined specified activities.

15. The integrated personnel management system of claim 1,
wherein billing data for bills includes time charges for individual timekeepers with specified rates per hour, and flat charges for individual activities.

16. The integrated personnel management system of claim 15,
wherein the flat charges for individual activities vary by client.

17. The integrated personnel management system of claim 15,
wherein billing data for bills further includes accumulated administrative costs on a per page basis.

18. The integrated personnel management system of claim 15,
wherein billing data for bills further includes accumulated administrative costs on a per minute basis.

19. The integrated personnel management system of claim 15,
wherein billing data for bills further includes accumulated administrative costs on a per instance basis.

20. The integrated personnel management system of claim 1,
wherein different software programs for billing, docketing and document management are integrated together such that input of information using one of the billing, docketing and document management software programs results in automatic generation by one of the at least one computer processor of bills or dockets or documents using the other two of the billing, docketing and document management software programs.
